(19) United States
(12) Patent Application Publication
(10) Pub. No.: US 2026/0133611 A1
(43) Pub. Date: May 14, 2026

(54) A SYSTEM AND A METHOD OF CONTROLLING TWO OR MORE ELECTRICAL FANS

(71) Applicant: Zerro Power Systems Pte Ltd, Singapore (SG)

(72) Inventors: Sehat SUTARDJA, Las Vegas, NV (US); Krishnamoorthy RAVISHANKER, Singapore (SG)

(21) Appl. No.: 19/118,441

(22) PCT Filed: Oct. 3, 2023
(86) PCT No.: PCT/SG2023/050660

§ 371 Date: Apr. 4, 2025

(30) Foreign Application Priority Data
Oct. 4, 2022 (SG) 10202251266X

(51) Int. Cl. G06F 1/20

(52) U.S. Cl. CPC G06F 1/20

(57) ABSTRACT

There is provided a system and a method of controlling two or more electrical fans, the system comprising, a first electrical fan having blades configured to rotate upon provision of electrical power; a second electrical fan having blades configured to rotate upon provision of electrical power; and a controller for controlling the provision of electrical power to the first electrical fan and the second electrical fan, wherein the provision of electrical power to the second electrical fan is configured to occur at a time period after the provision of electrical power to the first electrical fan to initiate rotation of the blades of the first electrical fan.

### TECHNICAL FIELD

The present disclosure relates broadly to a system and a method of controlling two or more electrical fans.

### BACKGROUND

When a device/equipment having one or more electrical fans is started up, there is typically a spike in the amount of power drawn by the device to initiate operation of components such as motor(s) for driving the electrical fan(s). In a single electrical fan configuration, the electrical fan is typically controlled by a single driver integrated circuit (IC). In a dual electrical fan configuration, two similar electrical fans are mounted together and typically each electrical fan has its own driver IC.

During startup of an electrical fan driven by a motor, the motor typically draws more current to start from a stationary state than when it is running at speed, e.g., full speed, unless it is being actively controlled by the driver IC. That is, the initial startup current (or inrush current) may be significantly greater than the steady state (or operating) current of the motor. One effect of a higher startup current on the system is that a larger power supply is required, as compared to what is required during steady state operation when the motor is running at speed. Another effect is that the initial startup current can be damaging to the motor or the power supply, thereby reducing the operational lifespan of the device.

The above problem is exacerbated in the case of a device having multiple electrical fans. For example, when two combined electrical fans are powered up, without special control, the startup currents from the individual motors add up. Again, this results in the requirement for a larger power supply than what is needed to keep the motor spinning.

Thus, there is a need for a system and a method of controlling two or more electrical fans that seek to address or alleviate at least one of the above problems.

### SUMMARY

In accordance with a first aspect of the present disclosure, there is provided a system for controlling two or more electrical fans, the system comprising, a first electrical fan having blades configured to rotate upon provision of electrical power; a second electrical fan having blades configured to rotate upon provision of electrical power; and a controller for controlling the provision of electrical power to the first electrical fan and the second electrical fan, wherein the provision of electrical power to the second electrical fan is configured to occur at a time period after the provision of electrical power to the first electrical fan to initiate rotation of the blades of the first electrical fan.

In the system of the present disclosure, the time period may be selected such that the electrical power provided to the second electrical fan does not overlap with a startup phase of the first electrical fan.

In the system of the present disclosure, the time period may comprise the time taken for the first electrical fan to reach a steady state upon an initial provision of electrical power to the first electrical fan.

In the system of the present disclosure, the steady state may occur when the first electrical fan is drawing a steady electrical current while maintaining rotation of the blades of the first electrical fan.

In the system of the present disclosure, the steady state may occur when the first electrical fan is rotating at a substantially constant speed.

In the system of the present disclosure, the first and second electrical fans may be electrically connected to a power supply configured to provide electrical power, such that the first and second electrical fans are allowed to respectively draw electrical current from the power supply.

In the system of the present disclosure, the first and second electrical fans may be axially aligned such that the axes of rotation of the blades of the first and second electrical fans lie along the same line.

In the system of the present disclosure, the blades of the second electrical fan may be configured to rotate passively when the first electrical fan is powered to initiate rotation of the blades of the first electrical fan; and the time period may be selected such that the provision of electrical power to the second electrical fan is synchronized with a passive rotating speed of the blades of the second electrical fan.

In the system of the present disclosure, the time period may be selected such that the passive rotating speed of the blades of the second electrical fan is above a threshold level before electrical power is provided to the second electrical fan.

In the system of the present disclosure, the electrical power may be supplied to respective motors of the first and second electrical fans.

In accordance with a second aspect of the present disclosure, there is provided a method of controlling two or more electrical fans, the method comprising, providing electrical power to a first electrical fan to initiate rotation of blades of the first electrical fan; and providing electrical power to a second electrical fan to rotate blades of the second electrical fan, said provision of electrical power to the second electrical fan occurring at a time period after providing electrical power to the first electrical fan to initiate rotation of the blades of the first electrical fan.

In the method of the present disclosure, the time period may be selected such that the electrical current provided to the second electrical fan does not overlap with a startup phase of the first electrical fan.

In the method of the present disclosure, the time period may comprise the time taken for the first electrical fan to reach a steady state upon an initial provision of electrical power to the first electrical fan.

In the method of the present disclosure, the steady state may occur when the first electrical fan is drawing a steady electrical current while maintaining rotation of the blades of the first electrical fan.

In the method of the present disclosure, the steady state may occur when the first electrical fan is rotating at a substantially constant speed.

In the method of the present disclosure, the step of providing power to the first and second electrical fans may comprise electrically connecting the first and second electrical fans to a power supply, and allowing the respective first and second electrical fans to draw electrical current from the power supply.

In the method of the present disclosure, the first and second electrical fans may be axially aligned such that the axes of rotation of the blades of the first and second electrical fans lie along the same line.

In the method of the present disclosure, the step of powering the first electrical fan to initiate rotation of the blades of the first electrical fan may cause the blades of the second electrical fan to rotate passively; and the time period may be selected such that the step of providing electrical power to the second electrical fan is synchronized with a passive rotating speed of the blades of the second electrical fan.

In the method of the present disclosure, the time period may be selected such that the passive rotating speed of the blades of the second electrical fan is above a threshold level before electrical power is provided to the second electrical fan.

In the method of the present disclosure, the electrical power may be supplied to respective motors of the first and second electrical fans.

### BRIEF DESCRIPTION OF THE DRAWINGS

Exemplary embodiments of the invention will be better understood and readily apparent to one of ordinary skill in the art from the following written description, by way of example only, and in conjunction with the drawings, in which:

FIG. 1 is a schematic block diagram of a system for controlling two or more electrical fans in an example embodiment.

FIG. 2 is a schematic flowchart illustrating a method of controlling two or more electrical fans in an example embodiment.

FIG. 3A is a photograph showing a single electrical fan in an example embodiment. FIG. 3B is a graph showing a time-varying current profile of the single electrical fan in the example embodiment.

FIG. 4A is a photograph showing a dual electrical fans setup of a first electrical fan and a second electrical fan in an example embodiment.

FIG. 4B is a graph showing time-varying current profiles of the dual electrical fans in the example embodiment.

FIG. 5 is a graph showing time-varying current profiles of a dual electrical fan setup where an electrical current provided to a second electrical fan does not overlap with a startup phase of a first electrical fan when a startup electrical current is provided to the first electrical fan in an example embodiment.

FIG. 6 is a graph showing time-varying current profiles of a dual electrical fan setup where an electrical current provided to a second electrical fan is synchronized with a passive rotating speed of the second electrical fan in an example embodiment.

### DETAILED DESCRIPTION

Example, non-limiting embodiments may provide a system and a method of controlling two or more electrical fans.

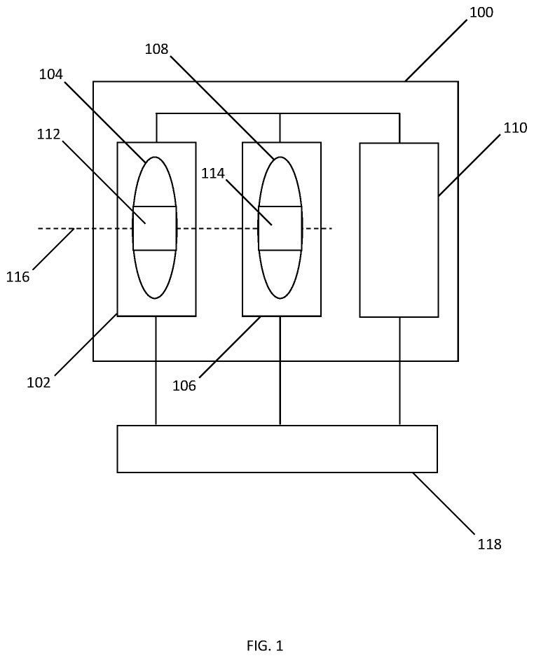

FIG. 1 is a schematic block diagram of a system 100 for controlling two or more electrical fans in an example embodiment.

In the example embodiment, the system 100 comprises a first electrical fan 102 having blades 104 configured to rotate upon provision of electrical power; a second electrical fan 106 having blades 108 configured to rotate upon provision of electrical power; and a controller 110 for controlling the provision of electrical power to the first electrical fan 102 and the second electrical fan 106; wherein the provision of electrical power to the second electrical fan 106 is configured to occur at a time period after the provision of electrical power to the first electrical fan 102 to initiate rotation of the blades 104 of the first electrical fan 102.

In the example embodiment, the first electrical fan 102 comprises a first motor 112 and the second electrical fan 106 comprises a second motor 114. The first motor 112 and the second motor 114 are coupled to and configured to rotate the blades 104 of the first electrical fan 102 and the blades 108 of the second electrical fan 106, respectively. The first motor 112 and second motor 114 may be electric motors. In the example embodiment, the electrical power is provided to the respective motors 112, 114 of the first and second electrical fans 102, 106. The first motor 112 and second motor 114 may each comprise a rotor and stator. The first motor 112 and second motor 114 may each comprise a rotating shaft for rotating the first electrical fan 102 and second electrical fan 106, respectively. The rotating shaft of the first motor 112 and the rotating shaft of the second motor 114 may be substantially axially aligned, i.e., disposed along a straight line 116 acting as a common axis of rotation. In the example embodiment, the two separate motors 112, 114 allow the first electrical fan 102 and second electrical fan 106 to operate independently of each other. It would be appreciated that the construction of a motor, e.g., electric motor that converts electrical energy into mechanical energy to operate the fans by rotating the fan blades would be understood by a person skilled in the art and is not further described herein.

In the example embodiment, the controller unit 110 is electrically coupled to the first electrical fan 102 and the second electrical fan 104. In the example embodiment, the controller unit 110 is configured to control the provision of electrical power to the first and second electrical fans 102, 106. In the example embodiment, the controller unit 100 may comprise an RC delay circuit to introduce a time delay in the provision of electrical power to the second electrical fan 106. In the example embodiment, the controller unit 110 may comprise a timer circuit, a microcontroller, a programmable logic controller (PLC), or a relay-based control system to introduce a time delay in the provision of electrical power to the second electrical fan 106. In the example embodiment, the controller unit 110 may further comprise relays or contactors (i.e., electromechanical switches) that can control the provision of electrical power to the electrical fans 102, 104. In the example embodiment, the controller unit 110 may further comprise a timing device for introducing a time delay in the provision of electrical power to the second electrical fan 104, e.g., a digital timer, an adjustable delay relay.

In the example embodiment, the system 100 may be coupled to a power supply 118 configured to provide electrical power. In the example embodiment, the power supply 118 is an external power supply. In other example embodiments, the power supply 118 may be an internal power supply. The power supply 118 may be a household power supply, an industrial power supply, or may be a battery or a charger built internally within the system 100. In the example embodiment, the system 100 may advantageously lower the requirements of the power supply 118 needed to operate the electrical fans 102, 106.

In the example embodiment, the provision of electrical power to the second electrical fan 106 at a time period after the provision of electrical power to the first electrical fan 102 advantageously reduces/lowers the total instantaneous power required when starting up the electrical fans 102, 106 in a staggered fashion, as compared to starting up the electrical fans 102, 106 at the same time. In the example embodiment, a delayed startup of the second electrical fan 106 may help to prevent power surges, reduce wear and tear, and improve safety of operation. In the example embodiment, the instantaneous power supplied/provided to respective fans may be separated into two phases-a startup phase and a steady state phase. During the startup phase, there is an initial surge of current that flows through an electric motor when it is first switched on from a stationery state. This surge in current is typically higher than the motor's rated operating current and is caused by the sudden demand for power as the motor and fan blades of the fan accelerate from a standstill to its operating speed. This initial surge of current is also referred to as the startup current. The startup current is a transient condition that occurs only when the motor is initially turned on. Once the motor and blades of the fan reaches its operating speed, the power supplied to the fan is in steady state phase where the current typically drops to a substantially steady value (i.e., steady state current), which is what the motor will draw during the normal operation. In practice, the startup current can be several times higher than the steady state current of the motor.

In the example embodiment, the time period may comprise the time taken for the first electrical fan 102 to reach a steady state phase upon an initial provision of electrical power to the first electrical fan 102. In the example embodiment, steady state phase may occur when the first electrical fan 102 is drawing a steady electrical current while maintaining rotation of the blades 104 of the first electrical fan 102. In the example embodiment, steady state phase may occur when the first electrical fan 102 is rotating at a substantially constant speed, after the initial provision of electrical power. In the example embodiment, the steady state phase may occur after the startup phase. In the example embodiment, the time period may be in the order of seconds, or in the order of milliseconds. In the example embodiment, the time period may be about one second to several seconds. During the steady state phase, the steady state current remains within an acceptable range. In practice, minor variations in the steady state current may occur and are considered acceptable as long as they do not significantly affect operation of the electrical fans 102, 104. The level of steady state current may depend on the specific device/application where the electrical fans are used. Typically, the steady state current is based on an optimization between the time needed to spin up the blades of the electrical fans and the total current required. In general, the smaller the initial/startup current, the longer is the spin-up time, and vice versa. Some systems may require a faster spin-up while some other systems may require the startup current to be within certain limits.

In some example embodiments, the time period may be selected such that the electrical current provided to the second electrical fan does not overlap with a startup phase of the first electrical fan. For example, an electrical current may be supplied to the first electrical fan 102 at a first time point to initiate rotation of the first electrical fan and an electrical current may be supplied to the second electrical fan 106 at a second time point. The electrical currents supplied to the first electrical fan 102 at the first time point and the second electrical fan 106 at the second time point may be startup currents. The second time point may be selected such that the startup current to the second electrical fan 106 does not overlap with the startup phase of the first electrical fan 102.

In other example embodiments, the time period may be selected such that the provision of electrical power to the second electrical fan 106 is synchronized with or based on a passive rotating speed of the blades 108 of the second electrical fan 106. For example, the blades 108 of the second electrical fan 106 may rotate passively (i.e., not actively driven by its motor) when the first electrical fan 102 is powered to initiate rotation of the blades 104 of the first electrical fan 102. The passive rotation of the blades 108 of the second electrical fan 106 may be due to the flow of air propelled by the first electrical fan 102. That is, air propelled from the first electrical fan 102 causes the blades 108 of the second electrical fan 106 to rotate passively. In such other example embodiments, the time period may be selected such that the passive rotating speed of the blades 108 of the second electrical fan 106 is above a threshold level/speed before electrical power is provided to the second electrical fan 106. The threshold speed of rotation of the blades 108 of the second electrical fan 106 may fall in the range of from about 100 revolutions per minute (RPM) to about 20,000 RPM. The threshold speed of rotation of the blades 108 of the second electrical fan 106 may fall in the range with start and end points selected from the following group of numbers: 100, 200, 300, 400, 500, 600, 700, 800, 900, 1000, 1500, 2000, 2500, 3000, 3500, 4000, 4500, 5000, 5500, 6000, 6500, 7000, 7500, 8000, 8500, 9000, 9500, 10000, 10500, 11000, 11500, 12000, 12500, 13000, 13500, 14000, 14500, 15000, 15500, 16000, 16500, 17000, 17500, 18000, 18500, 19000, 19500, and 20000 RPM. In such other embodiments, the system 100 may further comprise a sensor, e.g., speed sensor, coupled to the second electrical fan 106, for measuring the passive rotating speed of the blades 108 of the second electrical fan 106. The controller unit 110 may be configured to receive feedback from the sensor on the rotational speed of the blades 108 of the second electrical fan 106. The controller unit 110 may be further configured to control the amount of electrical power provided to the second electrical fan 106 based on the feedback provided by the sensor and the time period for providing electrical power to the second electrical fan 106. By synchronizing the provision of electrical power to the second electrical fan 106 with the passive rotating speed of the blades 108 of the second electrical fan 106, the startup phase of the second electrical fan 106 can be completely avoided. That is, there may be no need to supply a startup current to the second electrical fan 106 to initiate rotation of the blades 108 from a stationary state.

In the example embodiment, the system 100 may be comprised in devices and systems that utilize electrical fans. For example, the system 100 may be comprised in a hand-held hairdryer. For the purpose of illustration, two electrical fans 102, 106 are described in the example embodiment. However, it will be appreciated that the underlying concept behind the system 100 for controlling the two electrical fans 102, 106 may be extended to control a system having more than two electrical fans.

In the example embodiment, the first electrical fan 102 and the second electrical fan 106 may be substantially axially aligned such that the axes of rotation of the blades 104, 108 of the first and second electrical fans 102, 106 lie along the same line, i.e., the common axis of rotation 116. In other example embodiments, the first electrical fan 102 and the second electrical fan 106 may not be axially aligned to share a common axis of rotation.

In the example embodiment, the first and second electrical fans 102, 106 may have the same or different number of blades. The first electrical fan 102 may have more blades as compared to the second electrical fan 106. The first electrical fan 102 may have less blades as compared to the second electrical fan 106. In general, more blades may require less speed to achieve the same air flow. However, this may not be applicable to all fans. In the example embodiment, the number of blades in the first and second electrical fans 102, 106 may be a prime number, e.g., 3, 5, 7, 13, 17, 19 and the like. In the example embodiment, the first electrical fan 102 and/or second electrical fan 106 with a prime number of blades may advantageously ensure that there is no harmonic.

In the example embodiment, the blades 104, 108 of the first and second electrical fans 102, 106 may be curved or angled to create air flow along the axis of rotation 116, when the blades of the fans rotate. In the example embodiment, air may be propelled from the first electrical fan 102 towards the second electrical fan 106. In other example embodiments, air may be propelled from the first electrical fan 102 away from the second electrical fan 106. In the example embodiment, the first and second electrical fans 102, 106 may share the same axis of propulsion.

In the example embodiment, the blades 104 of the first electrical fan 102 may have the same size or different sizes as compared to the blades 108 of the second electrical fan 106. The blades 104 of the first electrical fan 102 may be longer than, shorter than, or of the same length as the blade 108 of the second electrical fan 106. The blades 104 of the first electrical fan 102 may have a larger surface area than, smaller surface area than, or the same surface area as the blade 108 of the second electrical fan 106. At the same rotation speed, larger blades are capable of moving more air than smaller blades. As such, a fan with larger blades may be configured to rotate at a slower/lower speed relative to a fan with smaller blades in order to match the air flow generated by the fan with smaller blades.

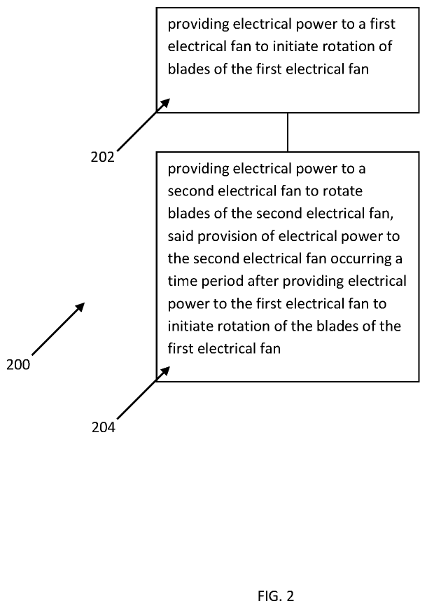

FIG. 2 is a schematic flowchart 200 illustrating a method of controlling two or more electrical fans in an example embodiment. At step 202, electrical power is provided to a first electrical fan to initiate rotation of blades of the first electrical fan. At step 204, electrical power is provided to a second electrical fan to rotate blades of the second electrical fan, said provision of electrical power to the second electrical fan occurring at a time period after providing electrical power to the first electrical fan to initiate rotation of the blades of the first electrical fan.

In the example embodiment, the method may further comprise electrically connecting the first and second electrical fans to a power supply (e.g., power supply 118 of FIG. 1), and allowing the respective first and second electrical fans to draw electrical current from the power supply. In the example embodiment, providing electrical power may comprise supplying electrical power to respective motors of the first and second electrical fans.

In the example embodiment, the time period comprises the time taken for the first electrical fan to reach a steady state upon an initial provision of electrical power to the first electrical fan. In other words, there is a time delay in providing electrical power to the second fan. In the example embodiment, steady state may occur when the first electrical fan is drawing a steady electrical current while maintaining rotation of the blades of the first electrical fan. In the example embodiment, steady state may occur when the first electrical fan is rotating at a substantially constant speed. In the example embodiment, steady state current refers to a substantially constant electrical current flowing through a circuit or component once it has reached a stable operating condition.

In some example embodiments, the time period is selected such that the electrical current provided to the second electrical fan does not overlap with a startup phase of the first electrical fan. In such example embodiments, the electrical current provided to the second electrical fan may be a startup electrical current.

In other example embodiments, the time period is selected such that the provision of electrical power to the second electrical fan is synchronized with or based on a passive rotating speed of the blades of the second electrical fan. When the first electrical fan is powered, the rotation of the blades of the first electrical fan causes the blades of the second electrical fan to rotate passively due to airflow propelled by the blades of the first electrical fan. The method may further comprise measuring the passive rotating speed of the blades of the second electrical fan using a sensor coupled to the second electrical fan. The method may further comprise providing a feedback signal to a controller unit based on the speed measured by the sensor. The method may further comprise controlling the amount of electrical power provided to the second electrical fan and determining the time period for providing electrical power to the second electrical fan. For example, the provision of electrical power to the second electrical fan may be gradually increased such that the electrical current drawn by the second electrical fan increase gradually over time to match the passive rotating speed of the blades of the second electrical fan. In such other example embodiments, the electrical current provided to the second electrical fan may not be a startup electrical current. In such other example embodiments, the method may be devoid of providing a startup electrical current to the second electrical fan. In such other example embodiments, the time period may be selected such that the passive rotating speed of the blades of the second electrical fan is above a threshold level when electrical power to the second electrical fan is provided.

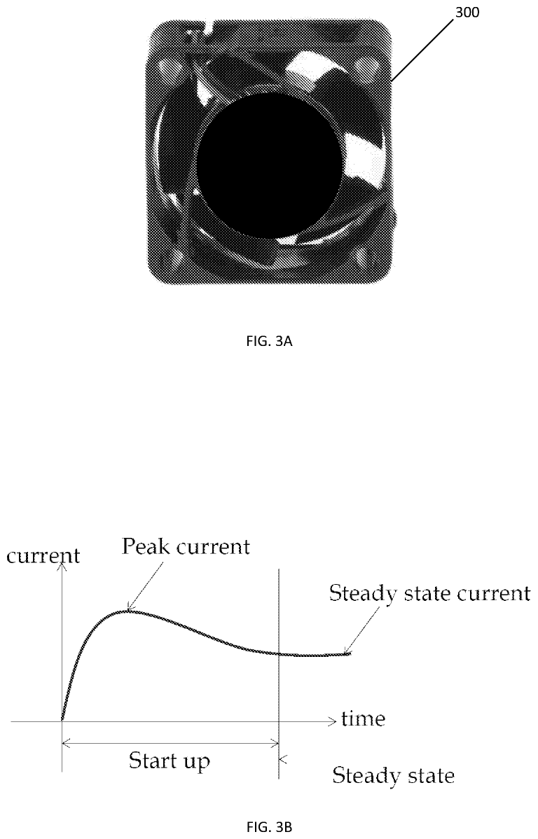

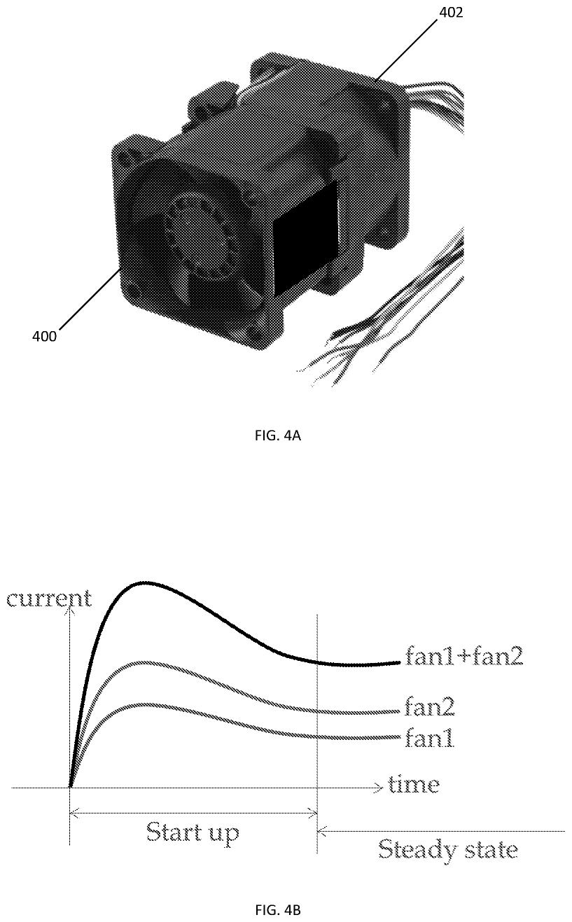

FIG. 3 and FIG. 4 illustrate a typical single electrical fan and dual electrical fans as well as their time varying current profiles in the absence of active control from startup to steady state operation of the electrical fans.

FIG. 3A is a photograph showing a single electrical fan 300 in an example embodiment. FIG. 3B is a graph showing a time-varying current profile of the single electrical fan 300 in the example embodiment. In a single electrical fan configuration, the electrical fan 300 is typically controlled by a single driver integrated circuit (IC) and driven by a motor, e.g., direct current (DC) motor. When initiating operation of the electrical fan 300, a startup current is supplied by a power source to start the motor from a standstill to its operating speed. The startup current can be several times higher than the motor's steady state current. Accordingly, the higher startup current requires a larger power supply than one needed to run the motor at the steady state running at speed.

FIG. 4A is a photograph showing a dual electrical fans setup of a first electrical fan 400 and a second electrical fan 402 in an example embodiment. FIG. 4B is a graph showing time-varying current profiles of the dual electrical fans 400, 402 in the example embodiment. In a dual electrical fan configuration, two similar electrical fans 400, 402 are mounted together and typically each electrical fan has its own driver IC and is driven by a motor, e.g., DC motor. As shown in FIG. 4B, when two combined electrical fans 400, 402 are powered up, with no special control, the startup currents from the individual motors add up. Accordingly, a larger power supply is required than what is needed to keep the motor spinning.

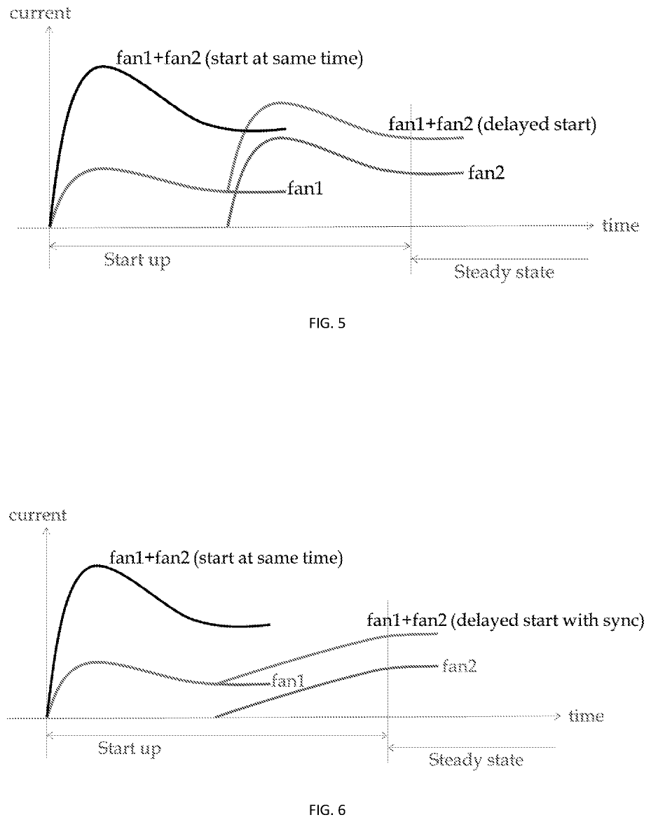

FIG. 5 and FIG. 6 illustrate time varying current profiles of a dual electrical fan setup achieved by the presently disclosed system and method with active control from startup to steady state operation of the electrical fans.

FIG. 5 is a graph showing time-varying current profiles of a dual electrical fans setup where an electrical current provided to a second electrical fan does not overlap with a startup phase of a first electrical fan when a startup electrical current is provided to the first electrical fan in an example embodiment. In the example embodiment, the provision of electrical current (i.e., startup electrical current) to the second electrical fan (see line labeled “fan 2”) occurs at a time period after the provision of electrical current (i.e., startup electrical current) to the first electrical fan (see line labeled “fan 1”). As shown in FIG. 5, if the first electrical fan is started first and the second electrical fan is started after a delay, such that the startup currents do not overlap, the maximum current (and hence instantaneous power) required will be lower than both fans starting at the same time (see lines labeled “fan1+fan2 (start at same time)” and “fan1+fan2 (delayed start)”).

FIG. 6 is a graph showing time-varying current profiles of a dual electrical fans setup where an electrical current provided to a second electrical fan is synchronized with a passive rotating speed of the second electrical fan in an example embodiment. In the example embodiment, provision of electrical power to the second electrical fan occurs at a time period after providing electrical power to the first electrical fan to initiate rotation of blades. The time period is selected such that the provision of electrical power to the second electrical fan is synchronized with a passive rotating speed of the blades of the second electrical fan. When a first electrical fan is turned on, rotation of blades of the first electrical fan may cause blades of the second electrical fan to rotate passively even without being driven by a motor. The electrical current supplied to the second electrical fan increases gradually over time to match the passive rotating speed of the blades of the second electrical fan. As shown in FIG. 6, if the first electrical fan is started first (see line labeled “fan 1”), the second electrical fan may be passively moving due to the airflow created by the first electrical fan even without being driven. If the second electrical fan is started when the passive rotating speed is higher than a threshold speed and the second electrical fan control is synchronized with the passive rotating speed, the startup routine of the second electrical fan can be completely avoided, resulting in a significantly lower total current (see line label “fan 2”).

The terms “coupled” or “connected” as used in this description are intended to cover both directly connected or connected through one or more intermediate means, unless otherwise stated.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g., medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in Bluetooth technology. The computer program when loaded and executed on a suitable reader effectively results in an apparatus that can implement the steps of the described methods.

The example embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the example embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

In the described example embodiments, the system and method of controlling the electrical fans are described using two electrical fans for illustration purposes. It will be appreciated that the underlying concept behind the system and method of controlling the electrical fans are not limited as such, and may be extended to a system and method of controlling more than two electrical fans. For example, the system and the associated method may further comprise a third electrical fan having blades configured to rotate upon provision of electrical power. The provision of electrical power to the third fan may be configured to occur at a time period after providing electrical power to the second electrical fan to initiate rotation of the blades of the second electrical fan. In other words, electrical power may be provided to the first, second, third and subsequent electrical fans in a staggered or sequential manner. Advantageously, staggered startup of electrical fans may help to manage electrical loads and prevent issues associated with simultaneous startup. Even more advantageously, it may promote system reliability, protect equipment, and help to maintain a stable electrical supply, which are important for various industrial and commercial applications.

It will be appreciated by a person skilled in the art that other variations and/or modifications may be made to the specific embodiments without departing from the scope of the invention as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A system for controlling two or more electrical fans, the system comprising,
a first electrical fan having blades configured to rotate upon provision of electrical power;
a second electrical fan having blades configured to rotate upon provision of electrical power; and
a controller for controlling the provision of electrical power to the first electrical fan and the second electrical fan, wherein the provision of electrical power to the second electrical fan is configured to occur at a time period after the provision of electrical power to the first electrical fan to initiate rotation of the blades of the first electrical fan;
wherein the first and second electrical fans are axially aligned such that the axes of rotation of the blades of the first and second electrical fans lie along the same line;
wherein the blades of the second electrical fan are configured to rotate passively when the first electrical fan is powered to initiate rotation of the blades of the first electrical fan; and
wherein the time period is selected such that the provision of electrical power to the second electrical fan is synchronized with a passive rotating speed of the blades of the second electrical fan.

2. The system according to claim 1, wherein the time period is selected such that the electrical power provided to the second electrical fan does not overlap with a startup phase of the first electrical fan.

3. The system according to claim 1, wherein the time period comprises the time taken for the first electrical fan to reach a steady state upon an initial provision of electrical power to the first electrical fan.

4. The system according to claim 3, wherein steady state occurs when the first electrical fan is drawing a steady electrical current while maintaining rotation of the blades of the first electrical fan.

5. The system according to claim 3, wherein steady state occurs when the first electrical fan is rotating at a substantially constant speed.

6. The system according to claim 1, wherein the first and second electrical fans are electrically connected to a power supply configured to provide electrical power, such that the first and second electrical fans are allowed to respectively draw electrical current from the power supply.

7. The system according to claim 1, wherein the time period is selected such that the passive rotating speed of the blades of the second electrical fan is above a threshold level before electrical power is provided to the second electrical fan.

8. The system according to claim 1, wherein the electrical power is supplied to respective motors of the first and second electrical fans.

9. A method of controlling two or more electrical fans, the method comprising,
providing electrical power to a first electrical fan to initiate rotation of blades of the first electrical fan; and
providing electrical power to a second electrical fan to rotate blades of the second electrical fan, said provision of electrical power to the second electrical fan occurring at a time period after providing electrical power to the first electrical fan to initiate rotation of the blades of the first electrical fan;
wherein the first and second electrical fans are axially aligned such that the axes of rotation of the blades of the first and second electrical fans lie along the same line;
wherein powering the first electrical fan to initiate rotation of the blades of the first electrical fan causes the blades of the second electrical fan to rotate passively; and
wherein the time period is selected such that providing electrical power to the second electrical fan is synchronized with a passive rotating speed of the blades of the second electrical fan.

10. The method according to claim 9, wherein the time period is selected such that the electrical current provided to the second electrical fan does not overlap with a startup phase of the first electrical fan.

11. The method according to claim 9, wherein the time period comprises the time taken for the first electrical fan to reach a steady state upon an initial provision of electrical power to the first electrical fan.

12. The method according to claim 11, wherein steady state occurs when the first electrical fan is drawing a steady electrical current while maintaining rotation of the blades of the first electrical fan.

13. The method according to claim 11, wherein steady state occurs when the first electrical fan is rotating at a substantially constant speed.

14. The method according to any one of claims 9, wherein providing power to the first and second electrical fans comprises electrically connecting the first and second electrical fans to a power supply, and allowing the respective first and second electrical fans to draw electrical current from the power supply.

15. The method according to claim 9, wherein the time period is selected such that the passive rotating speed of the blades of the second electrical fan is above a threshold level before electrical power is provided to the second electrical fan.

16. The method according to claim 9, wherein the electrical power is supplied to respective motors of the first and second electrical fans.
